(19) United States
(12) Patent Application Publication
(10) Pub. No.: US 2025/0093683 A1
(43) Pub. Date: Mar. 20, 2025

(54) BLUE ENHANCER GLASSES

(71) Applicant: Arizona Board of Regents on Behalf of the University of Arizona, Tucson, AZ (US)

(72) Inventors: Michael Grandner, Tucson, AZ (US); Fabian Fernandez, Tucson, AZ (US); Brooke Jordan Mason, Tucson, AZ (US); Stanley K. H. Pau, Tucson, AZ (US)

(21) Appl. No.: 18/292,287

(22) PCT Filed: Jul. 25, 2022
(86) PCT No.: PCT/US2022/038215

§ 371 Date: Jan. 25, 2024

Related U.S. Application Data
(60) Provisional application No. 63/225,753, filed on Jul. 26, 2021.

(51) Int. Cl. G02C 7/10

(52) U.S. Cl. CPC G02C 7/104

(57) ABSTRACT

Methods and devices are described that rely on interference filter designs to provide a precise and granular spectral behavior by allowing emissions of circadian-active blue and green light to reach a viewer. An example wearable device includes one or more windows positioned to allow light from a light source to propagate toward a position of a wearer's eyes, and a spectral filter that includes a coating positioned on one or more sections of the one or more windows. The spectral filter includes a multi-layer stack of dielectric material with alternate high and low indices of refraction. The number of the layers and a thickness of each layer are selected to provide designed transmission and blocking characteristics to allow circadian-active spectra to reach the wearer's eyes while blocking spectral content other than the circadian-active spectra. The designed transmission and blocking characteristics include a contiguous transmission region and two contiguous blocking regions.

### CROSS-REFERENCE TO RELATED APPLICATION(S)

This application claims priority to the provisional application with Ser. No. 63/225,753 titled “BLUE ENHANCER GLASSES,” filed Jul. 26, 2021. The entire contents of the above noted provisional application are incorporated by reference as part of the disclosure of this document.

### TECHNICAL FIELD

The disclosed embodiments relate to eyewear and spectral filters.

### SUMMARY

Methods and devices are described that, among providing other features and benefits, relate to spectral filters and associated eyewear that are specifically designed to allow emissions of circadian-active blue and green light to reach the observer/occupant.

An example wearable device includes one or more windows positioned to allow light from a light source to propagate toward a position of a wearer's eyes, and a spectral filter that comprises a coating positioned on one or more sections of the one or more windows. The spectral filter includes a multi-layer stack of dielectric material with alternate high and low indices of refraction such that a layer having a high index of refraction is positioned above or below a layer having a low index of reflection, and a layer having a high index of refraction is positioned above or below a layer having a low index of reflection. The number of the layers and a thickness of each layer are selected to provide designed transmission and blocking characteristics to allow circadian-active spectra to reach the wearer's eyes while blocking spectral content other than the circadian-active spectra, The designed transmission and blocking characteristics include a contiguous transmission region within 455-560 nm band of wavelengths with a tolerance to within at least ±5 nm, and two contiguous blocking regions, a first one of the contiguous blocking regions extending below 455 nm and a second one of the contiguous blocking regions extending above 560 nm. The spectral filter is configured to block 80-100% of the spectral content in each of the contiguous blocking regions, and transmit 98%-100% of the spectral content in the contiguous transmission region.

### BRIEF DESCRIPTION OF THE DRAWINGS

FIG. 1 illustrates example spectral characteristics of dye-based (left) and pigment-based (right) filters.

FIG. 2A illustrates the solar radiation spectrum.

FIG. 2B illustrates the radiation spectrum of an example light emitting diode (LED).

FIG. 2C illustrates the spectrum of an example halogen lamp.

FIG. 3 illustrates a typical spectral sensitivity of the human eye.

FIG. 4A illustrates a spectral plot for a filter specifically designed to channel circadian-active light in accordance with an example embodiment.

FIG. 4B illustrates a set of parameters associated with the filter of FIG. 4A.

FIG. 5A illustrates a spectral plot for a filter specifically designed to transmit a range of circadian-active wavelengths in accordance with another example embodiment.

FIG. 5B illustrates a set of parameters associated with the filter of FIG. 5A.

FIG. 6 illustrates an example eyewear that incorporates the blue enhancer filters of the disclosed technology.

### DETAILED DESCRIPTION

The timing of the brain's circadian clock is set by schedules of natural sunlight exposure. All physiological processes in the body are synchronized to the signals sent from the brain's clock as it interprets these environmental light patterns. As such, the clock's estimation of whether it is daytime (presence of light) or nighttime (near absence of light) has widespread impacts on the timing and organization of the sleep-wake cycle. Electric room lighting can interfere with the circadian clock's estimation of day versus night because the photoreceptors in the eye that send information to the clock are activated by both natural sunlight and electric room lighting. Electric lighting can thus interfere with sleep because humans are most biologically prepared to sleep at night not during the day. If the clock interprets a daytime signal when sensing electric light, it will delay the timing of sleep and will have more difficulty communicating with the rest of the body so that a consolidated period of rest is coordinated at night.

The photoreceptors that transmit light information to the brain's clock are most sensitive to certain parts of the light spectrum. One photoreceptor, melanopsin, is expressed by a subpopulation of cells in the eye called intrinsically photosensitive retinal ganglion cells (ipRGCs). They are most activated by light occurring between 455-495 nm, which is perceived as “blue light.” A second important photoreceptor that relays information to the clock is expressed by cone cells in the retina that are sensitive to mid-wavelength light occurring between 500-560 nm, which is perceived as “green light.” Though blue and green light are only partial pieces of the overall visible spectrum (400-800 nm), they have outsized effects on how the brain's clock measures light exposure and interprets for itself and for the rest of the body the timing and length of the day versus the timing and length of the night.

The circuitry that comprises the brain's clock is different from the circuitry that comprises the image-forming visual system (i.e., the system that allows us to see). It is not clear how each of these systems changes during aging or in response to chronic age-related diseases. However, recent experimental data suggest that in each context—natural aging and age-related disease contexts such as Alzheimer's disease—there is a loss of ipRGCs, the cells capable of responding to blue light between 455-495 nm.

The disclosed embodiments, among other features and benefits, rely on interference filter designs that are implemented in a wearable device (e.g., glasses, goggles, etc.) or covering for a luminaire (e.g., a light source from a house lamp) that provide a precise and granular spectral behavior by allowing emissions of circadian-active blue and green light between 455-560 nm to reach the observer/occupant. The disclosed technology can be implemented by designing a lens that transmits only incident light occurring in this range (455-560 nm). The result of this precise channeling of circadian-active light is that observers and occupants can concentrate their exposure to specific kinds of light that are most important for setting the timekeeping of the brain's circadian clock. Selective channeling of light in this way can improve the circadian function of a younger person or maximize activation of the remaining population of ipRGCs that have survived during aging or during the course of a chronic, age-related disease.

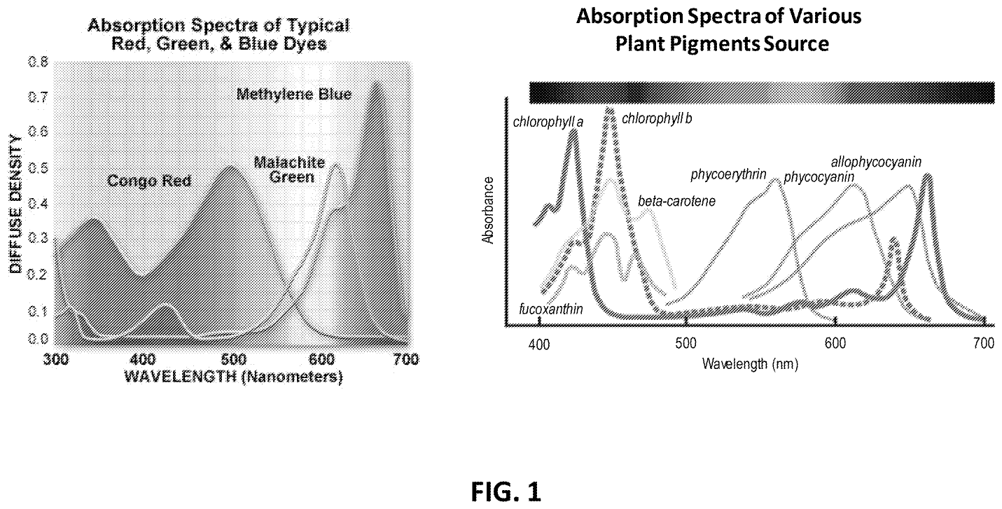

A large number of the existing systems rely on dye- or pigment-based filters that block or transmit a contiguous band of wavelengths but without a capability to selectively transmit or block narrower subbands within the larger contiguous band. Dye and pigment filters operate based on absorption of light by color dye and pigment embedded in a material such as polymer or sol-gel. The transmission spectrum of this type of filter has broad peaks shaped like a Gaussian function with linewidth equal to the inhomogeneous broadening of the materials. FIG. 1 illustrates example spectral characteristics of dye-based (left) and pigment-based (right) filters that exhibit this type of behavior. As also evident from FIG. 1, each spectrum includes a prominent peak with gradual fall off characteristics on both sides thereof. Thus the usefulness of these filters can be limited to applications where the desired spectral range happens to coincide with the spectral peak of the filter. But even then, the gradual falloff of the spectra can cause part of the desired spectrum to be filtered while allowing part of the undesired spectral content to seep through. In addition, the materials can be bleached under high light intensity, high temperature and/or corrosive environment.

Other types of filters include doped glass, semiconductor, metal, and metamaterial optical filters. Doped glass filters are made of a glass doped with a trace of impurity such as a metal and semiconductor nanocrystal, silver halides and cuprous ions. Semiconductor optical filters are made of semiconductor material with transmission edge determined by the bandgap. Metal optical filters are made by depositing several layers of metal or metallic alloy made of rhodium, palladium, tungsten, nickel and chromium on a transparent substrate and are used extensively as neutral density filters. Metamaterial optical filters are made of micro- and nano-fabricated structures with dimensions of the order of or smaller than the operating wavelength. Another class of optical filters are tunable optical filters with transmission spectra that can be changed by temperature, electric and/or magnetic field. Examples of tunable optical filters are liquid crystal, Fabry-Perot and MEMS filters. These types of filters are generally bulky and have a lower transmission than non-tunable filters.

The disclosed embodiments rely on multi-layer dielectric interference filter configurations to enable the precise spectral shaping that is required for precise channeling of the circadian-active blue and green light. Multi-layer dielectric or dichroic filters operate by optical interference instead of absorption. These filters are made by depositing multiple layers of dielectric coating such as magnesium fluoride, zinc sulfide, cerium dioxide, titanium dioxide, silicon oxide, zirconium dioxide to name a few. Interference filters can be designed to transmit light of different wavelength band with sharp transmission edge, in contrast to the broad band spectrum of the dye and pigment filter. The transmission spectrum of this type of filter is generally dependent on the angle of the incident light, although designs can be made to minimize the angular variation.

Several types of interference filters are described that relate to the features of the disclosed embodiments: long-wave pass, short-wave pass, notch (minus, bandstop), and band pass interference filter. A long-wave pass interference filter can include a multilayer structure and can be described using the following shorthand notation:

$${[ \frac{H}{2} L \frac{H}{2} ]}^{s} .$$

In the above expression, H denotes a quarter-wave high-index layer having a thickness λ₀/4n_{H} and H/2 denotes half of a quarter-wave high-index layer, i.e., one-eighth of a wave λ₀/8n_{H}. L denotes a quarter-wave low-index layer having a thickness λ₀/4n_{L}; s is an integer that denotes the number of basic periods (i.e., how many times the basis structure of high-low-high is repeated), λ₀ is the reference wavelength (i.e., the center wavelength used to design the filter), and n_{H,L} represents the high or the low refractive index, depending on whether the H or L subscript is used. A short-wave pass interference filter can include a multilayer structure and can be described by the following notation that follows a similar convention as described above:

$${[ \frac{L}{2} H \frac{L}{2} ]}^{s} .$$

A bandpass filter is a combination of long-wave pass and short-wave pass filters, and allows only a particular spectral band (i.e., the passband) to be transmitted. A notch filter blocks a particular band of wavelengths (i.e., the notch) but allows the remaining spectral content to pass therethrough. A notch filter can be implemented by using a multilayer structure, represented by the following notation:

[αLβH]^{s}αL.

In the above expression, α and β are numbers chosen for the location and width of the notch filter. For example, a notch filter with a reference wavelength at 550 nm and bandwidth of about 100 nm can be implemented using the multilayer structure represented by:

[1.68L0.30H]⁵⁹1.68L.

In the above example, α=1.68 and β=0.30.

One key advantage of the disclosed embodiments is the selective transmission and blocking of different wavelengths of light to match the photo receptor sensitivity of the human retina with high efficiency that maintains a high visibility. To this end, the coating on the lens that is part of the eyewear is specifically designed to elicit a particular biological response. To meet these requirements, the optical lens with the coating must satisfy two efficiency conditions: transmission efficiency and illumination efficiency. The transmission efficiency of a color filter can be described as:

$${η}_{T} = \frac{{{\int }_{{λ}_{1}}^{{λ}_{2}}}_{} d λ T ( λ )}{{{\int }_{{λ}_{3}}^{{λ}_{4}}}_{} d λ T ( λ )} .$$

In the above expression, η_{T} is the transmission efficiency; λ₁ and λ₂ are the lower and upper wavelengths, respectively, of the transmission band; λ₃ and λ₄ are the lower and upper wavelengths, respectively, of the incident illumination; and T(λ) is the filter transmission spectrum. Interference filters with sharp transition edge and low transmission ripple are used to achieve high η_{T}.

In addition, the illumination efficiency of a color filter can be described as:

$${η}_{i} = \frac{{\int }_{{λ}_{1}}^{{λ}_{2}} d λ S ( λ ) T ( λ ) ρ ( λ )}{{\int }_{{λ}_{3}}^{{λ}_{4}} d λ S ( λ ) ρ ( λ )} .$$

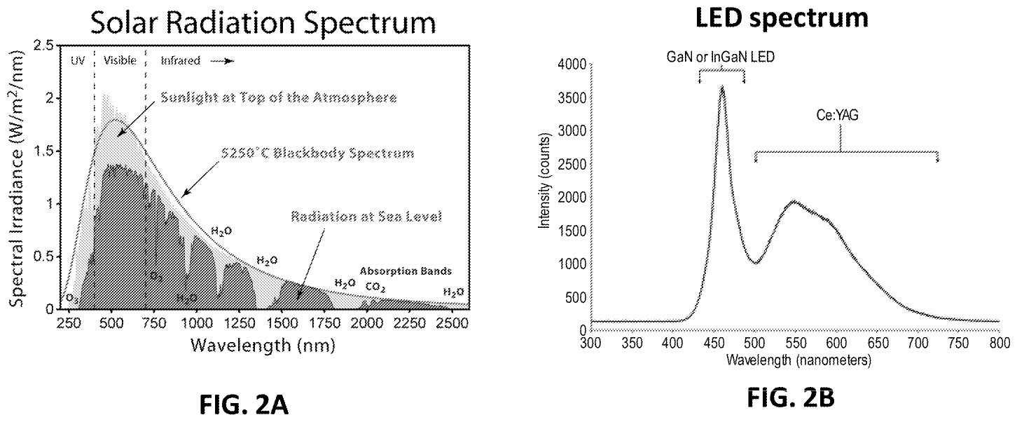

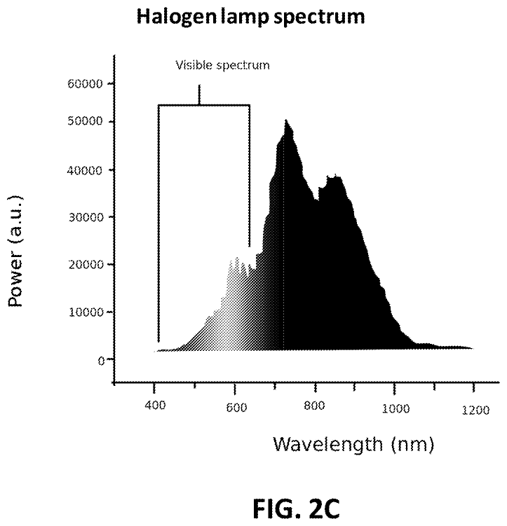

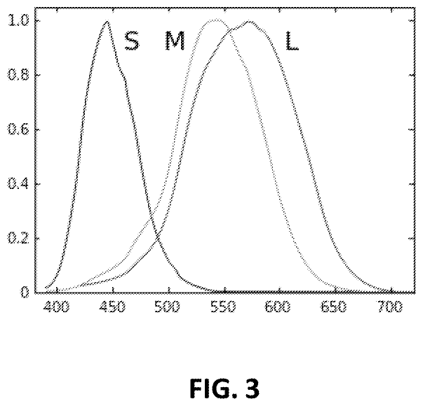

In the above expression, ηᵢ is the illumination efficiency; λ₁ and λ₂ are the lower and upper wavelengths, respectively, of the transmission band; λ₃ and λ₄ are the lower and upper wavelengths, respectively, of the incident illumination; S(λ) is the illumination spectrum; T(λ) is the filter transmission spectrum; and ρ(λ) is the human eye sensitivity. S(λ) can be the spectrum of the sun, a light emitting diode (LED), a halogen lamp, a fluorescent lamp, or another source of illumination. Example spectra of some of the above sources are presented in FIGS. 2A to 2C. In particular, FIG. 2A illustrates the solar radiation spectrum; FIG. 2B illustrates the radiation spectrum of an example LED; and FIG. 2C illustrates the spectrum of an example halogen lamp. FIG. 3 illustrates a typical spectral sensitivity of the human eye, and in particular, the normalized responsivity spectra for S-, M- and L-cone cells. The illumination efficiency of the lens must be high so that light visibility is not critically reduced during day and night.

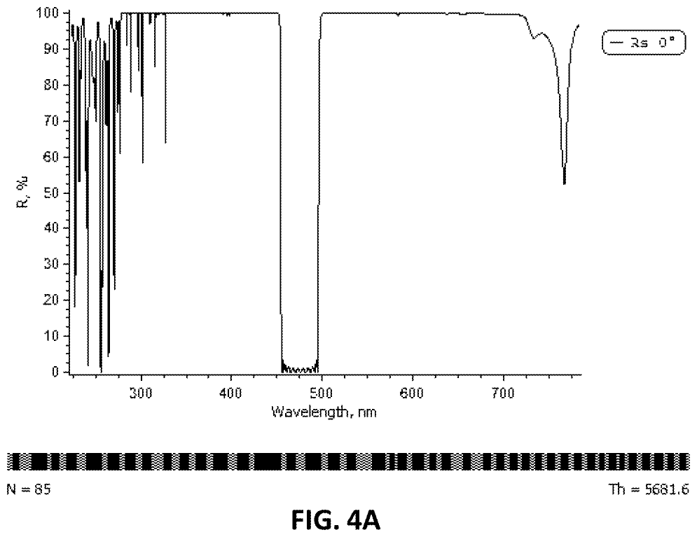

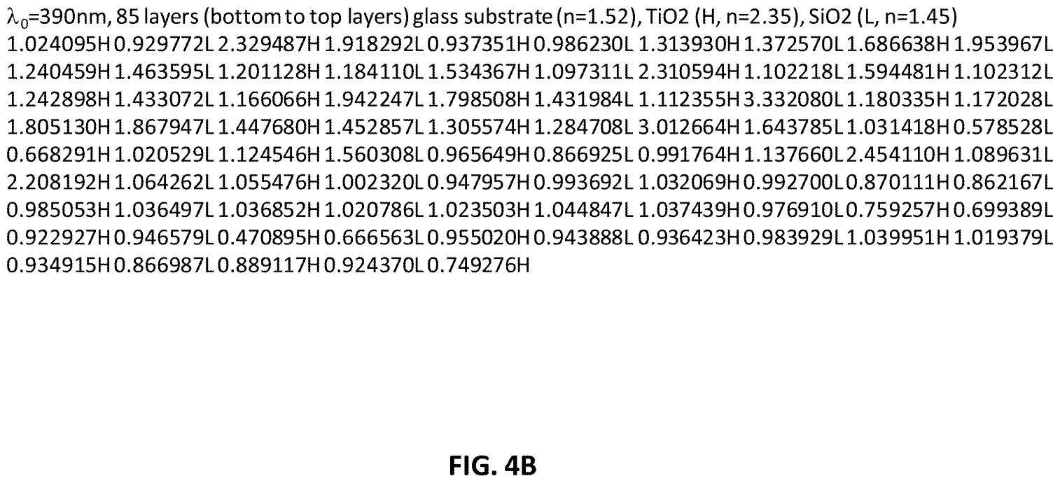

FIG. 4A illustrates a spectral plot for a filter specifically designed to channel circadian-active light in accordance with an example embodiment. The filter in FIG. 4A 4 allows very low reflection, and thus very high transmission (in some embodiments, close to 100%) of spectral content in the band 455-495 nm (±2 nm), while blocking (i.e., with nearly 0% transmission) of the remainder of the spectral content below 455 nm (to about 300 nm or lower), and above 495 nm (to about 725 nm). It should be noted that the spectral tolerance (listed in parenthesis) is selected to block all, or almost all, of the spectral content beyond the range 455-495 nm while allowing as much of the spectral content in the designed transmission band to be transmitted. The filter in FIG. 4A includes 85 dielectric layers stacked on top of a glass substrate (n=1.52), with high and low alternated layers that include TiO₂ (H, n=2.35) and SiO₂ (L, n=1.45), respectively. The thicknesses of the layers (using λ₀=390 nm as the reference wavelength) are listed in FIG. 4B. The transmission (or blockage) characteristics of the spectral bands can be modified by changing the number of layers in the design. For example, in some embodiments, the filter is designed to provide a blockage between 98-100%. In other filters, the blockage can be 95-98%. Yet in other designs, the blockage is 80-95%. In some example embodiments, the transmission is in the range 98-100%. Generally, the characteristics of the spectral bands can be fine-tuned by adding more layers to the design at the expense of increasing the cost of the filters.

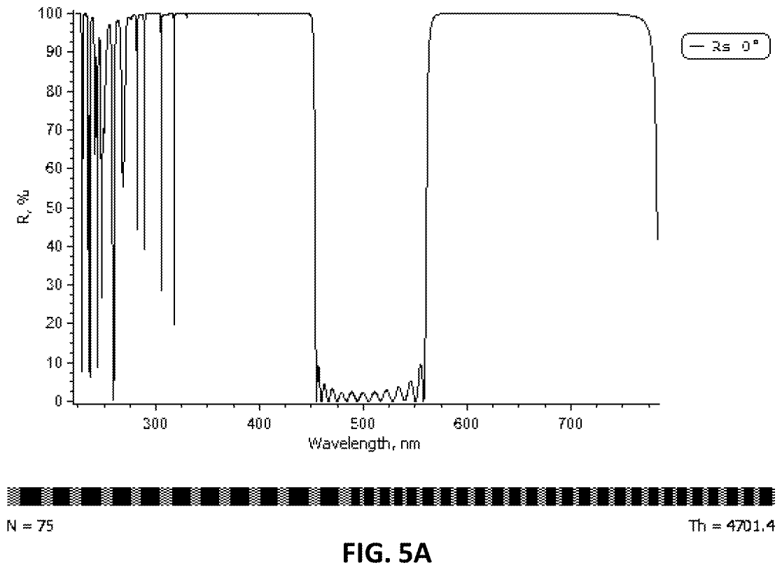

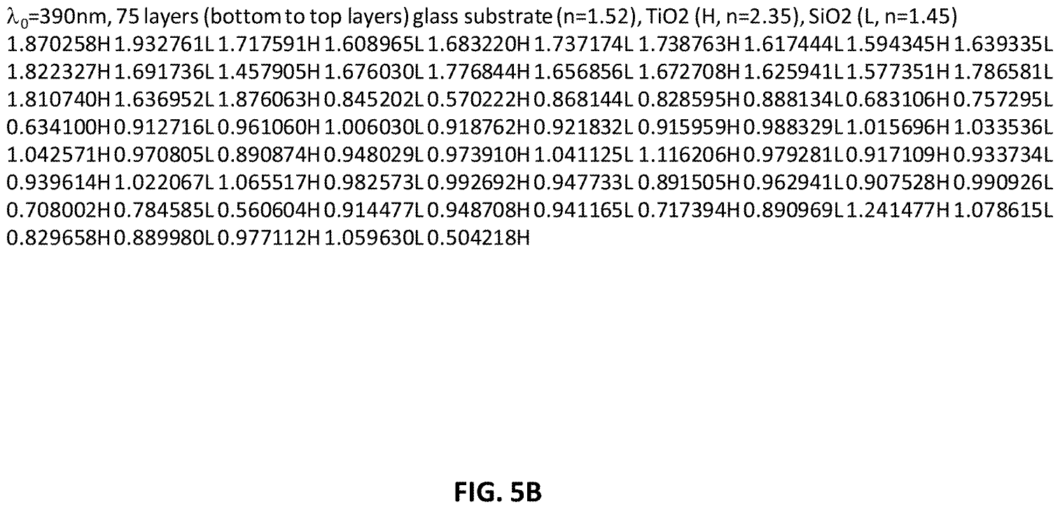

The filter in FIG. 4A is configured to allow substantially full transmission of the 455-495 nm band. FIG. 5A illustrates a spectral plot for a filter specifically designed to transmit a wider range of circadian-active wavelengths in accordance with an example embodiment. In particular, the filter in FIG. 5A includes a high transmission region (in some embodiments, with close to 100% transmission capability) in the band 455-560 nm (±2 nm), while blocking (i.e., with nearly 0% transmission) of the remainder of the spectral content below 455 nm (to about 300 nm), and above 560 nm (to beyond 750 nm). In addition to having extended transmission and blockage regions compared to FIG. 4A, the FIG. 5A filter has less ripple and sharper transitions in the transmission spectrum, which provides for a higher transmission efficiency. The filter has 75 dielectric layers stacked on top of a glass substrate with thicknesses that are listed in FIG. 5A.

Depending on the illuminating sources, the filter with the wider transmission bandwidth transmits more light and provides the user with higher visibility in low light environments. Generally, filter with more relaxed tolerances and lower number of layers is easier to manufacture, i.e., potentially has higher yield, and costs less.

Notably, the filters in FIGS. 4 and 5 block nearly 100% of light in the all spectral bands but those in the range 455-560 nm, and provide the further ability to select a particular subband (e.g., 455-495 nm band) within the larger circadian-active spectra. This capability allows the generation of a narrow spectral band for mitigating losses of ipRGCs associated with natural aging and age-related diseases.

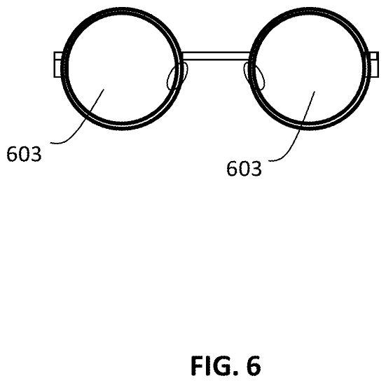

The disclosed filters can be implemented as part of specialized glasses or goggles. FIG. 6 illustrates a pair of example glasses that includes a pair of lenses 603 that can be coated with the disclosed filters. In some implementations, the glasses can include opaque side shields or blocks (not shown) to prevent side illumination to reach the eye. In some implementations, the side shields can be transparent and include filters with similar transmission and blocking characteristic as those on the lenses 603. The disclosed filters can be implemented as a coating provided on other types of eyewear, such as goggles. For instance, the wearable device can include a unitary transparent window that can be coated uniformly, or at particular locations thereon, with the disclosed filters having transmission and blockage characteristics at precisely tailored bands of the spectrum. For example, the particular locations of coatings can be selected to affect light that reaches the user's eyes at approximately normal angles. In another example, the coatings' locations and areal extent can be chosen to filter the light that reaches the user's eyes at both normal and inclined angles. In yet another example, the filters can be made detachable to existing eye wear, for example by small magnets or by screw-in adapter. The filters may also include an anti-reflection coating on the back side.

One aspect of the disclosed embodiments relates to a wearable device that includes one or more windows positioned to allow light from a light source to propagate toward a position of a wearer's eyes, and a spectral filter that comprises a coating positioned on one or more sections of the one or more windows. The spectral filter includes a multi-layer stack of dielectric material with alternate high and low indices of refraction such that a layer having a high index of refraction is positioned above or below a layer having a low index of reflection, and a layer having a high index of refraction is positioned above or below a layer having a low index of reflection. The number of the layers and a thickness of each layer are selected to provide designed transmission and blocking characteristics to allow circadian-active spectra to reach the wearer's eyes while blocking spectral content other than the circadian-active spectra, The designed transmission and blocking characteristics include a contiguous transmission region within 455-560 nm band of wavelengths with a tolerance to within at least ±5 nm, and two contiguous blocking regions, a first one of the contiguous blocking regions extending below 455 nm and a second one of the contiguous blocking regions extending above 560 nm. The spectral filter is configured to block 80-100% of the spectral content in each of the contiguous blocking regions, and transmit 98%-100% of the spectral content in the contiguous transmission region.

In one example embodiment, the contiguous transmission region extends from 455 nm to 495 nm, the first contiguous blocking region extends from 455 nm to 300 nm or below 300 nm, and the second contiguous blocking region extends from 495 nm to at least 700 nm, all with a ±2 nm tolerance. In another example embodiment, each layer with the high index of refraction includes titanium dioxide (TiO₂) and has a 2.35 index of refraction, and each layer with the low index of refraction includes silicon dioxide (SiO₂) and has a 1.45 index of refraction, and the multi-layer stack includes 85 layers.

In another example embodiment, the transmission region extends from 455 nm to 560 nm, the first blocking region extends from 455 nm to 300 nm or below 300 nm, and the second blocking region extends from 560 nm to at least 750 nm, all with a ±2 nm tolerance. In one configuration of this embodiment, each layer with the high index of refraction includes titanium dioxide (TiO₂) and has a 2.35 index of refraction, and each layer with the low index of refraction includes silicon dioxide (SiO₂) and has a 1.45 index of refraction, and the multi-layer stack includes 75 layers.

According to another example embodiment, the one or more windows includes two lenses, and the spectral filter is formed as the coating on each of the lenses. In yet another example embodiment, the wearable device is a pair of goggles, the one or more windows form a unitary window, and the spectral filter is formed as the coating on the unitary window. In still another example embodiment, the wearable device is a pair of goggles, the one or more windows form a unitary window, and the spectral filter is formed as the coating on two or more sections of the unitary window. For example, the two or more sections of the unitary window can be positioned to allow light propagating at substantially normal angles to pass through the spectral filter and reach a location of a wearer's eyes. In another example, the two or more sections of the unitary window are positioned to allow light propagating at one or more inclined angles to pass through the spectral filter and reach a location of a wearer's eyes.

In one example embodiment, the one or more windows are made of glass or plastic. In another example embodiment, the spectral filter is removably attached to the one or more windows. In yet another example embodiment, the wearable device is configured to receive input illumination from one or more light sources including an atmospheric light source, a light emitting diode (LED), a halogen lamp, or a fluorescent lamp. In still another example embodiment, the wearable device further includes an anti-reflection coating positioned on one side of the one or more windows.

Another aspect of the disclosed embodiments relates to a spectral filter for use in an eyewear for restoring circadian rhythm that includes a multi-layer stack coating on a substrate, the multi-layer stack including a plurality of layers of dielectric material with alternate high and low indices of refraction such that a layer having a high index of refraction is positioned above or below a layer having a low index of reflection, and a layer having a high index of refraction is positioned above or below a layer having a low index of reflection. The number of the layers and a thickness of each layer are selected to provide designed transmission and blocking characteristics to allow circadian-active spectra to be transmitted through the spectral filter. The designed transmission and blocking characteristics include a contiguous transmission region within 455-560 nm band of wavelengths with a tolerance to within at least ±5 nm, and two contiguous blocking regions, a first one of the contiguous blocking regions extending below 455 nm and a second one of the contiguous blocking regions extending above 560 nm. Each of the contiguous blocking regions blocks 80-100% of the spectral content in the corresponding blocking region, and the contiguous transmission region transmits 98-100% of the spectral content in the transmission region.

In one example embodiment, the contiguous transmission region extends from 455 nm to 495 nm, the first contiguous blocking region extends from 455 nm to 300 nm or below 300 nm, the second contiguous blocking region extends from 495 nm to at least 700 nm, all with a ±2 nm tolerance. In this example embodiment, each layer with the high index of refraction includes titanium dioxide (TiO₂) and has a 2.35 index of refraction, each layer with the low index of refraction includes silicon dioxide (SiO₂) and has a 1.45 index of refraction, and the multi-layer stack includes 85 layers.

According to another example embodiment, the contiguous transmission region extends from 455 nm to 560 nm, the first contiguous blocking region extends from 455 nm to 300 nm or below 300 nm, and the second contiguous blocking region extends from 560 nm to at least 750 nm, all with a ±2 nm tolerance. In this example embodiment, each layer with the high index of refraction includes titanium dioxide (TiO₂) and has a 2.35 index of refraction, each layer with the low index of refraction includes silicon dioxide (SiO₂) and has a 1.45 index of refraction, and the multi-layer stack includes 75 layers.

In yet another example embodiment, the spectral filter is configured to receive input illumination from one or more light sources including an atmospheric light source, a light emitting diode (LED), a halogen lamp, or a fluorescent lamp. In another example embodiment, the spectral filter does not include a dye-based or a pigment-based material.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. While operations are depicted in the drawings in a particular order, this should not be understood as requiring that such operations be performed in the particular order shown or in sequential order, or that all illustrated operations be performed, to achieve desirable results. The features of the embodiments described herein may be combined in all possible combinations of methods, apparatus, modules, and systems.

Only a few implementations and examples are described, and other implementations, enhancements and variations can be made based on what is described and illustrated in this patent document.

I/We claim:

1. A wearable device, comprising:
one or more windows positioned to allow light from a light source to propagate toward a position of a wearer's eyes; and
a spectral filter that comprises a coating positioned on one or more sections of the one or more windows,
wherein the spectral filter includes a multi-layer stack of dielectric material with alternate high and low indices of refraction such that a layer having a high index of refraction is positioned above or below a layer having a low index of reflection, and a layer having a high index of refraction is positioned above or below a layer having a low index of reflection,
wherein a number of the layers and a thickness of each layer are selected to provide designed transmission and blocking characteristics to allow circadian-active spectra to reach the wearer's eyes while blocking spectral content other than the circadian-active spectra,
wherein the designed transmission and blocking characteristics include a contiguous transmission region within 455-560 nm band of wavelengths with a tolerance to within at least ±5 nm, and two contiguous blocking regions, a first one of the contiguous blocking regions extending below 455 nm and a second one of the contiguous blocking regions extending above 560 nm, and
wherein the spectral filter is configured to block 80-100% of the spectral content in each of the contiguous blocking regions, and transmit 98%-100% of the spectral content in the contiguous transmission region.

2. The wearable device of claim 1, wherein the contiguous transmission region extends from 455 nm to 495 nm, the first contiguous blocking region extends from 455 nm to 300 nm or below 300 nm, and the second contiguous blocking region extends from 495 nm to at least 700 nm, all with a ±2 nm tolerance.

3. The wearable device of claim 2, wherein each layer with the high index of refraction includes titanium dioxide (TiO₂) and has a 2.35 index of refraction, and each layer with the low index of refraction includes silicon dioxide (SiO₂) and has a 1.45 index of refraction, and the multi-layer stack includes 85 layers.

4. The wearable device of claim 1, wherein the transmission region extends from 455 nm to 560 nm, the first blocking region extends from 455 nm to 300 nm or below 300 nm, and the second blocking region extends from 560 nm to at least 750 nm, all with a ±2 nm tolerance.

5. The wearable device of claim 4, wherein each layer with the high index of refraction includes titanium dioxide (TiO₂) and has a 2.35 index of refraction, and each layer with the low index of refraction includes silicon dioxide (SiO₂) and has a 1.45 index of refraction, and the multi-layer stack includes 75 layers.

6. The wearable device of claim 1, wherein the one or more windows includes two lenses, and the spectral filter is formed as the coating on each of the lenses.

7. The wearable device of claim 1, wherein the wearable device is a pair of goggles, the one or more windows form a unitary window, and the spectral filter is formed as the coating on the unitary window.

8. The wearable device of claim 1, wherein the wearable device is a pair of goggles, the one or more windows form a unitary window, and the spectral filter is formed as the coating on the two or more sections of the unitary window.

9. The wearable device of claim 8, wherein the two or more sections of the unitary window are positioned to allow light propagating at substantially normal angles to pass through the spectral filter and reach the position of the wearer's eyes.

10. The wearable device of claim 8, wherein the two or more sections of the unitary window are positioned to allow light propagating at one or more inclined angles to pass through the spectral filter and reach the position of the wearer's eyes.

11. The wearable device of claim 1, wherein the one or more windows are made of glass or plastic.

12. The wearable device of claim 1, wherein the spectral filter is removably attached to the one or more windows.

13. The wearable device of claim 1, wherein the light source is one of: an atmospheric light source, a light emitting diode (LED), a halogen lamp, or a fluorescent lamp.

14. The wearable device of claim 1, further including an anti-reflection coating positioned on one side of the one or more windows.

15. A spectral filter for use in an eyewear for restoring circadian rhythm, comprising:
a multi-layer stack coating on a substrate, the multi-layer stack including a plurality of layers of dielectric material with alternate high and low indices of refraction such that a layer having a high index of refraction is positioned above or below a layer having a low index of reflection, and a layer having a high index of refraction is positioned above or below a layer having a low index of reflection,
wherein a number of the layers and a thickness of each layer are selected to provide designed transmission and blocking characteristics to allow circadian-active spectra to be transmitted through the spectral filter,
wherein the designed transmission and blocking characteristics include a contiguous transmission region within 455-560 nm band of wavelengths with a tolerance to within at least ±5 nm, and two contiguous blocking regions, a first one of the contiguous blocking regions extending below 455 nm and a second one of the contiguous blocking regions extending above 560 nm,
wherein each of the contiguous blocking regions blocks 80-100% of the spectral content in the corresponding blocking region, and
wherein the contiguous transmission region transmits 98-100% of the spectral content in the transmission region.

16. The spectral filter of claim 15, wherein:
the contiguous transmission region extends from 455 nm to 495 nm, the first contiguous blocking region extends from 455 nm to 300 nm or below 300 nm, the second contiguous blocking region extends from 495 nm to at least 700 nm, all with a ±2 nm tolerance, and
each layer with the high index of refraction includes titanium dioxide (TiO₂) and has a 2.35 index of refraction, each layer with the low index of refraction includes silicon dioxide (SiO₂) and has a 1.45 index of refraction, and the multi-layer stack includes 85 layers.

17. The spectral filter of claim 15, wherein:
the contiguous transmission region extends from 455 nm to 560 nm, the first contiguous blocking region extends from 455 nm to 300 nm or below 300 nm, and the second contiguous blocking region extends from 560 nm to at least 750 nm, all with a ±2 nm tolerance, and
each layer with the high index of refraction includes titanium dioxide (TiO₂) and has a 2.35 index of refraction, each layer with the low index of refraction includes silicon dioxide (SiO₂) and has a 1.45 index of refraction, and the multi-layer stack includes 75 layers.

18. The spectral filter of claim 15, configured to receive input illumination from one or more light sources including an atmospheric light source, a light emitting diode (LED), a halogen lamp, or a fluorescent lamp.

19. The spectral filter of claim 15, wherein the spectral filter does not include a dye-based or a pigment-based material.
